(19) United States
(12) Patent Application Publication
(10) Pub. No.: US 2009/0211537 A1
(43) Pub. Date: Aug. 27, 2009

(54) PET TOY AND METHOD AND APPARATUS FOR FORMING THE PET TOY

(75) Inventors: Patrick M. Bertsch, Thornton, CO (US); Digger T. Mesch, Kowloon City (HK)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 12/038,576

(22) Filed: Feb. 27, 2008

(51) Int. Cl. A01K 29/00; A23G 9/00

(52) U.S. Cl. 119/707; 249/92

(57) ABSTRACT

A pet toy may include at least two portions. The first portion may be generally non-edible, and the second portion may be an at least partially frozen or otherwise solidified substance. The first portion may include a body defining an open area, and at least a portion of the frozen or otherwise solidified substance may be contained within the area. The first portion may be formed from rubber, plastic or nylon, and so on, and the second portion may be formed from water, broth, gravy, yogurt, and so on. The pet toy may be created using a pet toy mold. The pet toy mold may include the first portion of the pet toy and a body selectively joined to the first portion. The first portion and the body may define a chamber for receiving the frozen or otherwise solidified substance.

### FIELD OF INVENTION

The present invention generally relates to pet toys, and more particularly to pet toys that attract an animal to the toy and maintain the animal's interest in it.

### BACKGROUND

Pet owners often use pet toys to allow their pets, such as dogs or cats, to engage in natural, yet potentially destructive behaviors such as biting and chewing. For example, when the pet is chewing on a valuable item, the owner may substitute the pet toy for the item, thus allowing the animal to continue to chew on the pet toy while preserving the valuable item from damage or destruction from the animal's chewing. One way to attract an animal to a toy is putting food (or a treat) into the toy. The food not only attracts the animal to the toy, but also retains the animal's interest as the animal will generally try to remove the food from the toy. Although this may solve the problem of keeping the animal interested in the toy, the animal may quickly lose interest in it once the animal consumes the food. Furthermore, if the pet owner continues to place food in the toy to keep the animal attracted to it, the animal may eat too much food per day which may result in obesity or other health issues for the animal.

### BRIEF SUMMARY

One embodiment of the present invention may take the form of a pet toy including a generally non-edible portion and an at least partially solid edible portion. The non-edible portion may include a body defining an open area. The at least partially solid edible portion may be joined to the generally non-edible portion. The at least partially solid edible portion may comprise a substance converted from a liquid or semi-liquid state to an at least partially solid state. Conversion of the substance from the liquid or semi-liquid state to the at least partially solid state may join the at least partially solid edible portion to the generally non-edible portion. An outer surface of the pet toy may include both the generally non-edible portion and the at least partially solid edible portion. At least a part of the at least partially solid edible portion may be contained within the open area defined by the body of the non-edible portion.

Another embodiment of the present invention may take the form of a pet toy including a generally non-edible portion and a frozen liquid portion. The generally non-edible portion may include a body defining an open area. The frozen liquid may be portion joined to the generally non-edible portion. An outer surface of the pet toy may include both the generally non-edible portion and the frozen liquid portion. At least a part of the frozen liquid portion may be contained within the open area defined by the body of the non-edible portion.

Yet another embodiment of the present invention may take the form of a pet toy mold including a first body and a second body. The second body may be selectively joined to the first body. The first and second bodies may define a chamber. At least one of the first and second bodies may include a material that forms a substantially liquid-tight seal between the bodies when the first and second bodies are selectively joined.

### BRIEF DESCRIPTION OF THE DRAWINGS

FIG. 1 depicts a perspective view of a first embodiment of a mold for creating a pet toy.

FIG. 2 depicts an exploded perspective view of the mold shown in FIG. 1.

FIG. 3 depicts an elevation view of the mold shown in FIG. 1.

FIG. 4 depicts another elevation view of the mold shown in FIG. 1.

FIG. 5 depicts a top plan view of the mold shown in FIG. 1.

FIG. 6 depicts a bottom plan view of the mold shown in FIG. 1.

FIG. 7 depicts an exploded perspective cross-section view of the mold shown in FIG. 1.

FIG. 8 depicts a pet toy formed using the mold shown in FIG. 1.

FIG. 9 depicts a cross-section view of the pet toy shown in FIG. 8.

FIG. 10 depicts a perspective view of a second embodiment of a pet toy mold.

FIG. 11 depicts an exploded perspective view of the pet toy mold shown in FIG. 10.

FIG. 12 depicts a side elevation view of the pet toy mold shown in FIG. 10.

FIG. 13 depicts an end elevation view of the pet toy mold shown in FIG. 10.

FIG. 14 depicts a top plan view of the pet toy mold shown in FIG. 10.

FIG. 15 depicts a perspective view of a first body of the pet toy mold shown in FIG. 10.

FIG. 16 depicts a exploded perspective cross-section view of the pet toy mold shown in FIG. 10.

FIG. 17 depicts a pet toy formed using the pet toy mold shown in FIG. 10.

FIG. 18 depicts a cross-section view of the pet toy shown in FIG. 17.

### DETAILED DESCRIPTION

Described herein are a pet toy for use by a pet such as a dog, a cat, or other domesticated animal and a pet toy mold for creating the pet toy. The pet toy may take the form of a generally non-edible portion or body joined to an edible portion or body. The generally non-edible portion or body may be at least a component of a pet toy mold used to create the pet toy. The edible portion or body may be a liquid or semi-liquid substance converted to an at least partially frozen or solid substance. The non-edible portion or body may be composed of a material relatively safe for an animal to chew, bite, or lick, such as rubber or the like. The edible portion or body may be a substance that is safe for an animal to chew and/or digest, such as water, broth, gravy, yogurt, and so on.

The pet toy mold for forming the pet toy may include a first body and a second body selectively separable from the first body. Together, the first and second bodies may define a chamber for receiving a substance in a liquid or semi-liquid state. At least one of the bodies may include at least one hole to fill at least a portion of the chamber with the liquid or semi-liquid substance. The mold may be placed in an environment having a temperature sufficiently low to at least partially freeze or otherwise solidify the substance. The environment may be an apparatus such as a freezer or the like. Once the substance is sufficiently frozen or otherwise solid, the first and second bodies may be removed from the freezing environment and separated to expose at least a portion of the at least partially frozen or otherwise solid substance. Further, the at least partially frozen or otherwise solid substance may remain joined to at least one of the first and second bodies such that the body and the at least partially frozen or otherwise solid substance together form the pet toy.

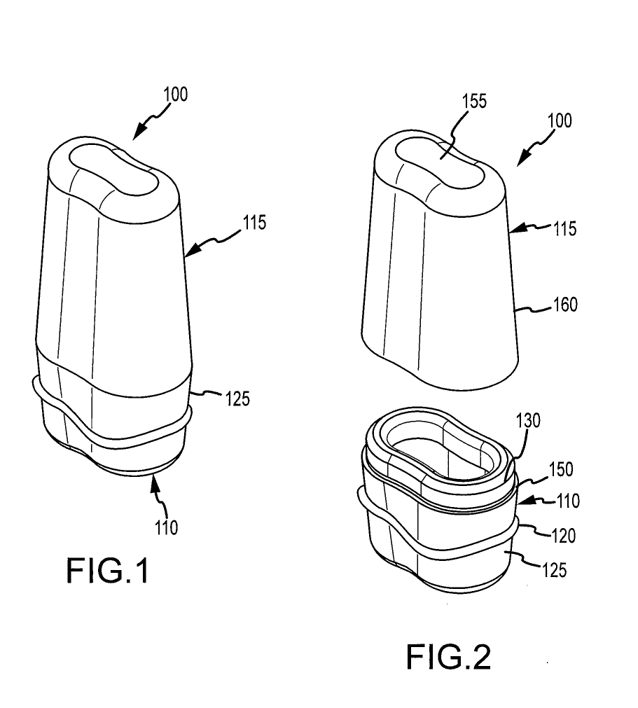

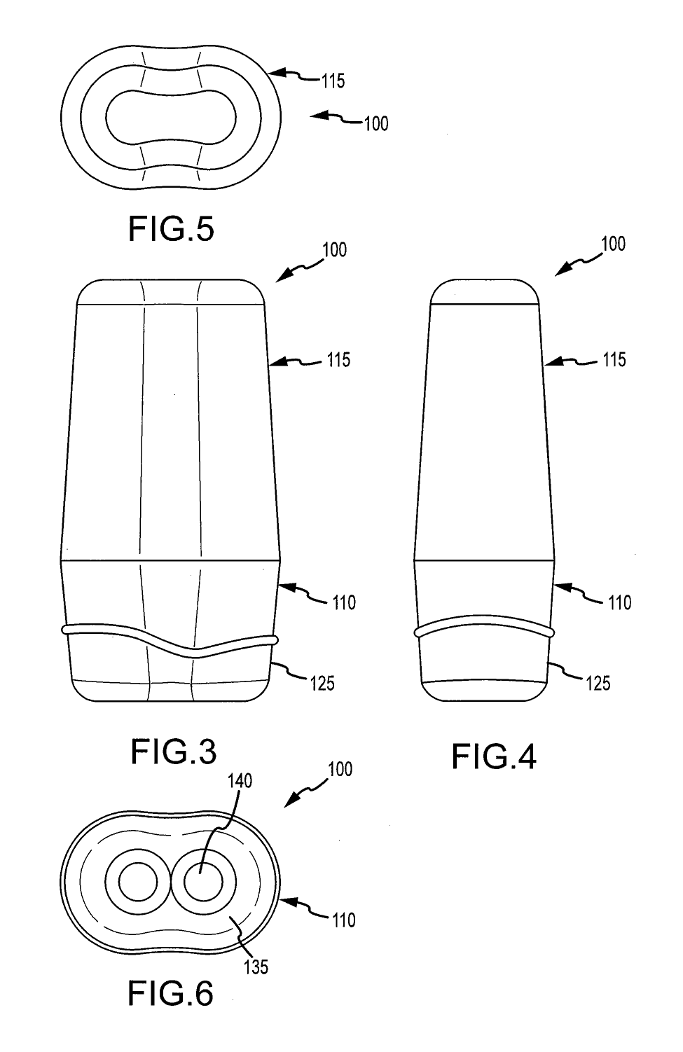

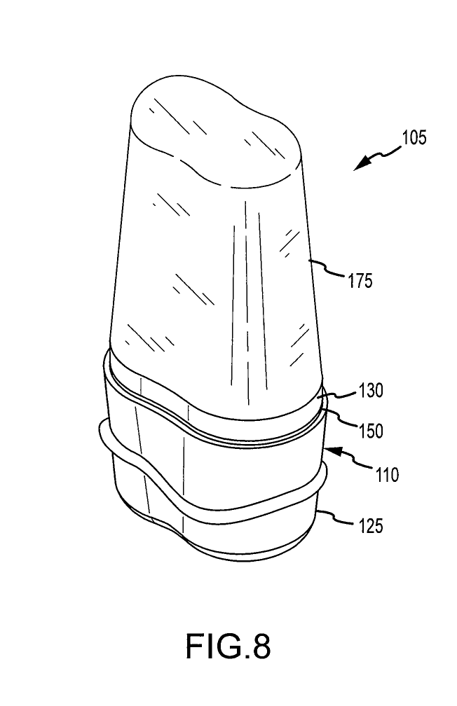

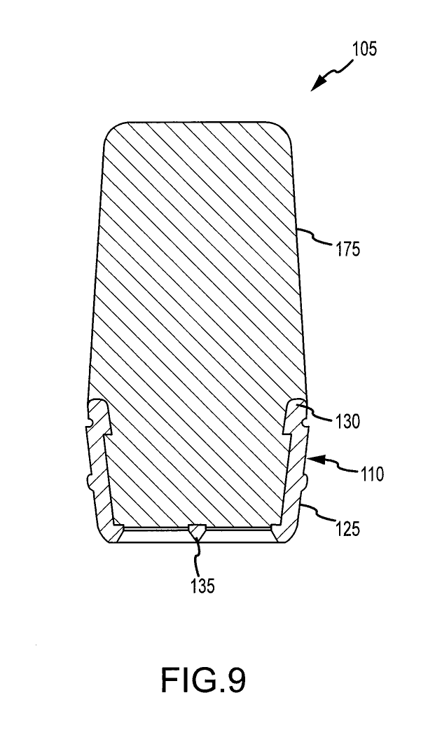

FIGS. 1-7 depict a first embodiment of a pet toy mold 100 for creating a pet toy, and FIGS. 8 and 9 depict a pet toy 105 formed using the pet toy mold 100 shown in FIGS. 1-7. The pet toy mold 100 may be formed from two or more bodies. In the embodiment depicted in FIGS. 1-7, the pet toy mold 100 includes first and second bodies 110, 115. The pet toy mold 100, however, may include more than two bodies, if desired. When joined, the first and second bodies 110, 115 may define a generally oblong, tubular structure.

The first body 110 may be composed of a material generally safe for an animal to chew, bite, or lick. In some embodiments, the first body 110 may be a flexible plastic or rubber or any other material that provides both flexibility and durability when chewed or bitten by an animal. In other embodiments, the first body 110 may be a more rigid plastic or rubber, nylon, or other material that provides durability with minimal flexibility. The second body 115 may be composed from a similar material as the first body 110, or may be composed of different material, including any material potentially used for the first body 110 or other materials such a metal or other materials that generally retain their formed shape when subjected to freezing and thawing cycles. Yet further, for embodiments having more than two bodies, each body may be composed of any material described for the first and second bodies 110, 115. The material may be selected based upon whether or not the particular body is intended to form a portion of the pet toy created using the pet mold 100.

One or both bodies 110, 115 may include ridges, grooves, recesses, or other shapes formed in or attached to the body. The ridges, grooves, recesses or other shapes may be decorative and/or may provide dental cleaning or gum massaging functions. The grooves or recesses may also receive and retain pet treats or other food. For the embodiment depicted in FIGS. 1-7, the first body 110 includes a ridge 120 that generally extends around a perimeter of the first body 110. The ridge, however, may be omitted from the first body, or additional ridges or other shapes may be added to the first body 110, if desired. In the depicted embodiment, the second body 115 does not include decorative and/or functional features like the first body 110. As with the first body 110, however, one or more ridges or other shapes may be formed on or attached to the second body 115, if desired.

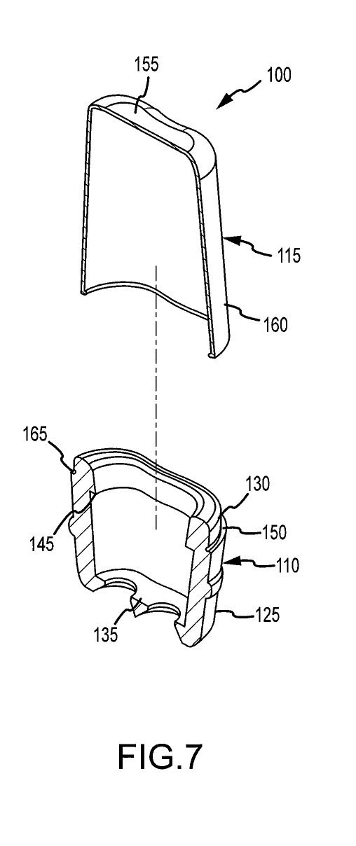

Turning to FIGS. 2 and 7, the first body 110 may include a lower sidewall 125, an upper sidewall 130, and a base 135. The upper and lower sidewalls 130, 125 and the base 135 may be integrally formed by any known method (e.g., casting, molding and the like) or formed from individual pieces joined by any known method (e.g., welding, adhering, fastening, and the like). The inner surfaces of the lower and upper sidewalls 125, 130 and the base 135 may define a generally open space suitable for receiving an object, such as a fluid. The base 135 may include one or more holes 140 that extend from an outer surface to the inner surface of the base 135.

Although two holes 140 are shown in FIGS. 5 and 7, more or less than two holes may be defined in the base 135 or in other sections of the first body 110. The holes 140 may be used to fill a chamber defined by the first and second bodies 110, 115 with a fluid, such as water, or other substance in a liquid or semi-liquid state. When two or more holes 140 are provided, at least one of the holes may be used to fill the chamber and another of the holes may function as a vent to limit formation of air bubbles within the liquid or semi-liquid substance. A vent hole also aids in filling the chamber with the liquid or semi-liquid substance.

With continued reference to FIGS. 2 and 7, the upper sidewall 130 may extend from an upper end of the lower sidewall 125. The upper and lower sidewalls 130, 125 may define an inner ledge 145. The inner ledge 145 may anchor an at least partially frozen or otherwise solid substance to the first body 110. Other structures may also be used, if desired, to anchor the at least partially frozen or otherwise solid substance to the first body 110. For example, one or more shaft or column-like structures may be extended into the open space from one or more of the inner surfaces of the first body 110. As another example, grooves or recess may be defined in one or more of the inner surfaces of the first body 110. The foregoing examples are merely illustrative and are not intended to be limiting.

The upper and lower sidewalls 130, 125 may also define an outer ledge 150. The outer ledge 150 may have a width as measured from an exterior surface of the upper sidewall 130 to an exterior surface of the lower sidewall 125 that generally equals a wall thickness of the second body 115 at a lower end of the second body 115. Such a configuration results in a lower outer surface of the second body 115 generally aligning with an adjacent outer surface of the first body 110 when the first and second bodies 110, 115 are joined, as shown, for example, in FIG. 1. The outer surfaces of the first and second bodies 110, 115, however, do not need to align.

The upper and lower sidewalls' 130, 125 and the base's 135 thicknesses may be selected to provide sufficient flexibility to allow the first body 110 to deform inwardly towards the first open area when an animal bites the first body 110, yet sufficiently thick to minimize the potential for the animal to puncture the first body 110 with its teeth. The range of thicknesses for upper and lower sidewalls and bases with such characteristics may depend upon the first body's material properties and the shape of the base and upper and lower sidewalls.

Turning back to FIGS. 2 and 7, the second body 115 may include a cover 155 and a second body sidewall 160 extending from the cover 155. The cover 155 may include a generally planar surface. The cover planar surface may be engaged with a support surface to support the pet toy mold in a position such that the holes 140 in the first body 110 are generally above the chamber defined by the first and second bodies 110, 115. Inner surfaces of the cover 155 and second body sidewall 160 may define a second open area or space suitable for receiving an object, such as a fluid. When the first and second bodies 110, 115 are selectively joined as shown, for example in FIG. 1, the first open space of the first body 110 and the second open space of the second body 115 may define the chamber, which may receive a fluid or other liquid or semi-liquid substance. As discussed above, the holes 140 in the first body 110 may provide access to the chamber for placing such a substance within the chamber. In some embodiments, the holes 140 may be formed in the second body 115 rather than the first body 110, may be formed in each body 110, 115, or may be omitted from both bodies 110, 115.

The second body 115 may be joined to the first body 110 by a press-fit connection. A perimeter of the second body inner surface at a lower end portion of the second body 115 may generally match a perimeter of the outer surface of the first body upper sidewall 130. Such a configuration may provide for a relatively snug-tight connection between the first and second bodies 110, 115. Further, when either the first or second bodies 110, 115 include a rubber or other elastomeric material, a substantially liquid-tight seal may be formed at the connection joint formed by the first and second bodies 110, 115, thus limiting the leakage of fluid contained within the chamber through this joint. Although shown as connected by press-fit, any other known connection method, or combination of connection methods, that allows for the bodies 110, 115 to be selectively joined and disconnected may be used, including, but not limited to, mechanical fasteners, hook-and-look fastening systems, bayonet fastening systems, threaded fastening systems, snap fastening systems and so on.

The pet toy mold 100 may further include a tongue and groove or other such connection detail to enhance the fluid seal between the first and second bodies 110, 115. With reference to FIG. 7, a groove 165 may be defined in the upper sidewall 130 of the first body 110, and a tongue or flange 170 may extend from a lower end portion of the second body 115. The groove 165 may be sized to receive the tongue 170. When the first and second bodies 110, 115 are joined, the tongue 170 may be received within the groove 165, thus enhancing the fluid seal between the first and second bodies 110, 115. In some embodiments, the tongue 170 may extend from the first body 110, and the groove 165 may be defined in the second body 115.

Other systems, methods or devices for forming a fluid seal between the first and second bodies 110, 115 may be used in place of, or in combination with, the tongue and groove connection. For example, one or more O-rings, cup seals or other fluid seal elements may be positioned between the first and second bodies 110, 115. O-ring grooves or other structures may be defined in the first and/or second bodies 110, 115 for retaining and/or receiving any O-rings, cup seals or the like. The O-rings, cup seals or the like may be composed of elastomeric or other suitable material. The foregoing example is merely illustrative and is not intended to imply or require any particular fluid seal system, method or device.

Although not shown, the pet toy mold 100 may include one or more plugs or other appropriate structures for selective placement in any hole 140 formed in the first or second bodies 110, 115. Such plugs may be used to selectively open or close the holes 140, thus allowing access to the chamber to be selectively allowed or restricted. When not received within or otherwise closing a hole 140, any such plugs may or may not be permanently or releasably attached to the pet toy mold 100 by any known method, including, but not limited to, by a strap, chain, rope, or the like. If plugs are used, attaching them to the pet toy mold 100 when not received within a hole 140 may reduce the potential for them to be misplaced or lost.

With reference to FIGS. 8 and 9, a pet toy 105 formed using the pet toy mold 100 may include the first body 110 and an at least partially frozen or otherwise solid substance 175. At least a part of the at least partially frozen or otherwise solid substance 175 may be contained within the first open space defined by the first body 110. The first body 110 may be composed of a material generally safe for an animal to chew, bite, or lick, such as rubber or the like. The at least partially frozen or otherwise solid substance 175 may be a liquid or semi-liquid substance that is converted from a liquid or semi-liquid state to an at least partially frozen or otherwise solid state by subjecting the substance to a temperature sufficient to convert the substance from a liquid or semi-liquid state to a solid state. The substance may further be selected from a liquid or semi-liquid substance that is generally safe for an animal to chew, bite or lick. The substance may yet further be generally safe for consumption by the animal. Some possible liquid or semi-liquid substances include water, broth, gravy, or yogurt. Water takes the form of ice when frozen, which many animals enjoy chewing. Additionally, water tends to be relatively easy for a pet owner to clean compared to edible substances such as gravies, broths, yogurts and so on, which may stain or stick to floors, furniture or other items. Yet further, water is a substance that may be consumed without increasing the risk for the animal to become obese or overweight from consuming it.

Solid pet treats or other generally solid food may be placed within the liquid or semi-liquid substance prior to or during freezing or solidifying the substance to embed or combine such food with the substance for removal and/or consumption by the animal as it plays with the pet toy. Other objects may also be placed within the liquid or semi-liquid substance prior to or during freezing or solidifying the substance to embed or combine such objects with the frozen or otherwise solidified substance for removal by the animal or to attract the animal to the pet toy. For example, objects that make noise when the toy is moved may be combined with the liquid or semi-liquid substance to further attract the animal to the toy.

An operation for forming a pet toy 105 using the pet toy mold 100 will now be described with references to FIGS. 1-9. The first and second bodies 110, 115 may be joined to define a chamber for holding a liquid or semi-liquid substance. The chamber may be filled with the substance using the holes 140 formed in the one of the bodies 110, 115. Optionally, solid pet treats, other solid foods, or other objects may be placed in the chamber with the liquid or semi-liquid substance. Such solid foods or objects may be placed in the chamber before or after adding the liquid or semi-liquid substance to the chamber, or may be mixed with the liquid or semi-liquid substance before adding the substance to the chamber.

The pet toy mold 100 containing the substance may be placed within a freezer or other environment having a temperature sufficiently low to convert the substance from a liquid to a solid state. The pet toy mold 100 may be positioned such that any holes 140 in the pet toy mold 100 face generally upward to limit the potential for the substance to exit the chamber through the holes 140 prior to freezing or solidifying. Alternatively, plugs or other suitable structures may be used to close any holes 140.

The pet toy mold 100 may be kept in the environment for a sufficient amount of time to convert at least a portion, up to substantially the whole portion, of the substance from a liquid to a solid or frozen state. Once at least some of the substance is converted to a solid or frozen state, the pet toy mold 100 may be removed from the environment. The second body 115 may then be separated from the first body portion 110 to uncover at least a portion of the at least partially solidified or frozen substance. The at least partially solidified or frozen substance may generally take the shape of the second area of the second body 115. For example, the exposed portion of the at least partially solidified or frozen substance 175 may resemble a generally rectangular column as shown in FIG. 8. The foregoing example is merely illustrative and is not intended to require any particular shape for the at least partially solidified or frozen substance. The pet toy 105 may then, if desired, be given to the animal.

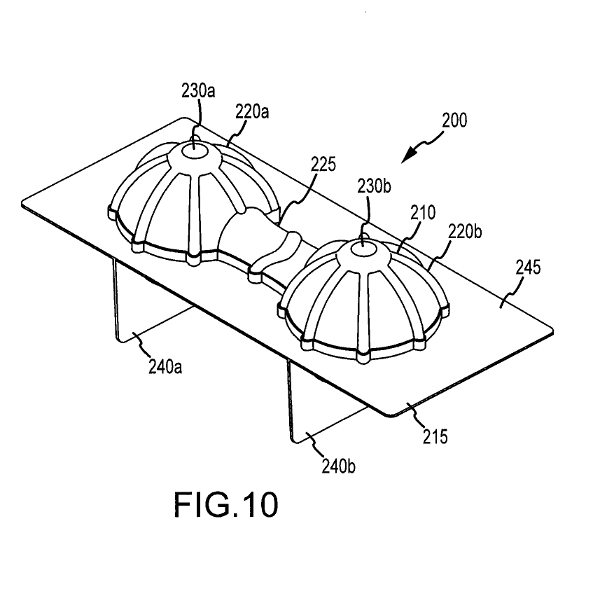

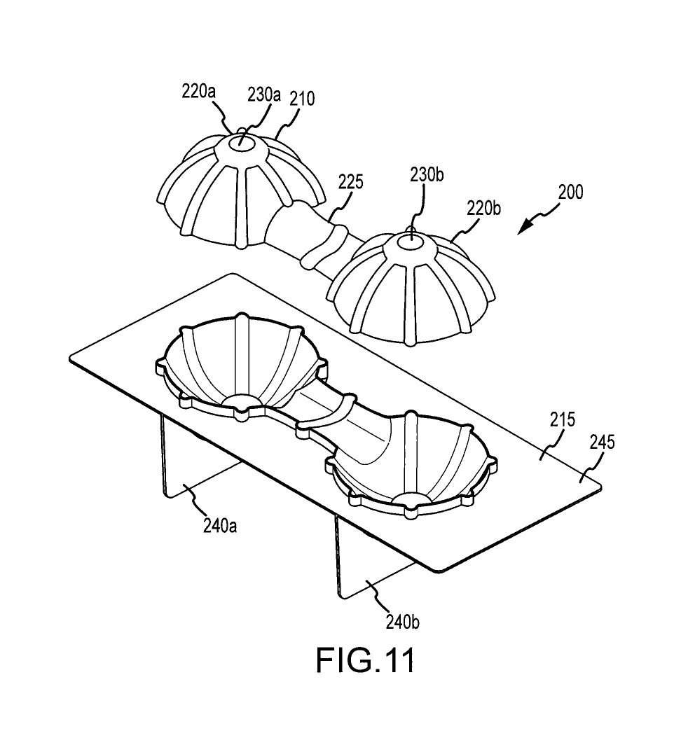

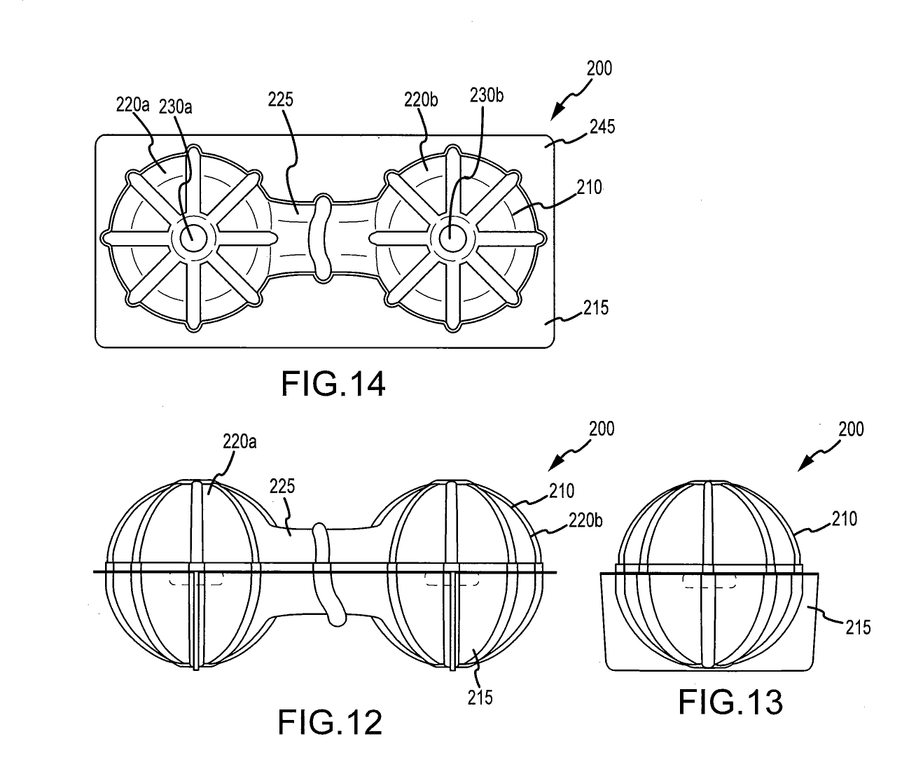

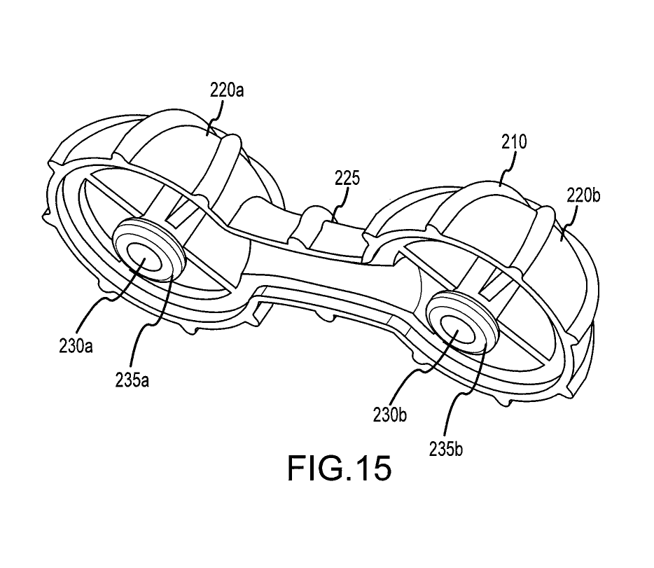

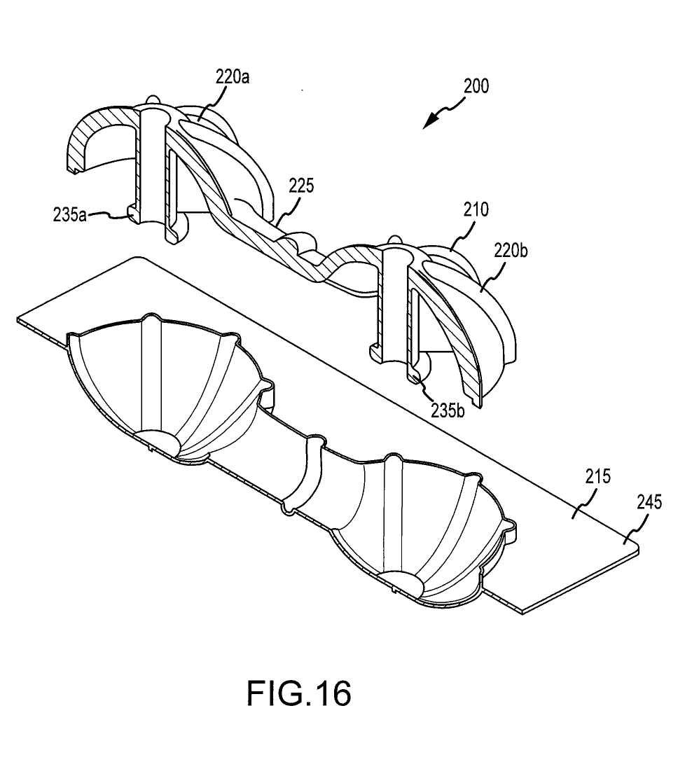

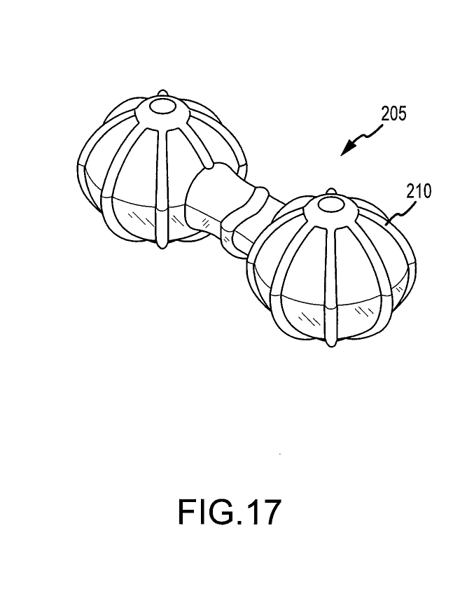

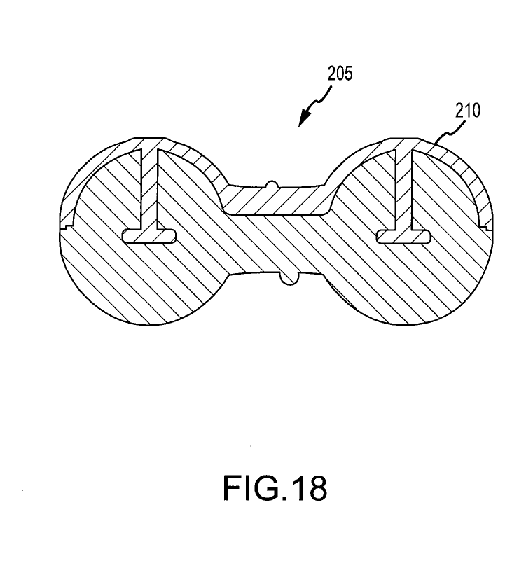

FIGS. 10-16 depict a second embodiment of a pet toy mold 200, and FIGS. 17 and 18 depict a pet toy 205 formed using the pet toy mold 200 shown in FIGS. 10-16. The second pet toy mold 200 is generally similar to the first pet toy mold 100 and operates in a generally similar manner. Like the first pet toy mold 100, the second pet toy mold 200 may include first and second bodies 210, 215 that when joined define a chamber for receiving a liquid or semi-liquid substance. The first body 210 may take a shape that forms a partial dog-bone or dumbbell. More particularly, the first body 210 may include two partial-spherical sections 220a, b joined by a partial cylindrical section 225.

Like the first body 110 for the first pet toy mold 100, the first body 210 for the second pet toy mold 200 may include decorative and/or functional features, holes, and an anchoring system. The decorative and/or functional features may take the form of multiple ridges formed on an outer surface of the first body portion. Each hole 230a, b may be defined in a partial spherical section 220a, b. The anchoring system may take the form of two columns 235a, b. Each column 235a, b may extend from an inner surface of the first body 210 proximate a partial spherical section 230a, b and may include a flange at its free end. Each column 235a, b may further include a passage that generally co-axially aligns with one of the holes 230a, b defined in the column's respective partial spherical section 220a, b.

The second body 215 may take the form of a tray 245 supported by two leg members 240a, b. The tray 245 may include a generally planar section that encompasses a recessed portion that generally resembles a partial dog-bone or dumbbell. More particularly, the recessed portion may include two partial spherical recessed areas joined together by a partial cylindrical recessed area. The recessed portion may be sized to receive a lower section of the first body 210 in order to join the first and second bodies 210, 215 by press-fit. As with the first pet toy mold 100, however, the first and second bodies 210, 215 of the second pet toy mold 200 may also by joined using any known connection method.

Each leg member 240a, b may extend generally downward from the tray 245. Each leg 240a, b may be generally centered under a partial spherical recessed area of the tray 245. The legs 240a, b may elevate the tray 245, including its recessed areas, above a support surface. If desired, the legs may be omitted, or more or less than two legs may be used. Further, the legs 240a, b may be positioned at any desired location with respect to recessed areas of the tray 245. The legs 240a, b may include generally flat lower ends for generally leveling the tray 245 when the legs 240a, b are supported by a generally horizontal support surfaces. If desired, the legs 240a, b may be telescoping or otherwise adjustable to level the tray 245 when the legs 240a, b are supported on a non-level surface.

With reference to FIGS. 17 and 18, a pet toy 205 formed using the second pet toy mold 200 may include the first body 210 and a frozen liquid or semi-liquid substance like the pet toy 105 formed using the first pet toy mold 100. Like the first pet toy 105, at least a part of the at least partially frozen or otherwise solid substance may be contained within the first open space defined by the first body 210. Like the first pet toy 100, the first body 210 of the second pet toy 205 may be composed of a material generally safe from an animal to chew, bite, or lick, such as rubber or the like, and the frozen or otherwise solid substance may be a liquid or semi-liquid substance that is converted from a liquid or semi-liquid state to a solid state by subjecting the substance to lowered temperatures.

The operation of forming a pet toy 205 using the second pet toy mold 200 is substantially similar to the operation described for the first pet toy mold 100. Like the first pet toy mold 100, the first and second bodies 205, 210 of the second pet toy mold 200 may be joined to define the chamber for receiving a liquid or semi-liquid substance. Also like the first pet toy mold 100, the chamber may be filled with solid food or other objects. The pet toy mold 200 may be placed in an environment having a temperature sufficiently low to at least partially convert the substance from a liquid or semi-liquid state to a solid and removed from the environment once the substance is at least partially solidified. Like the first pet toy 100, the second body 215 may be separated from the first body 210 to uncover at least a portion of the at least partially frozen of solidified substance, and the pet toy 205 given to the animal. Like the first pet toy 105, the exposed portion of the at least partially frozen or solidified substance may generally take the shape of the second open area of the second body 215. The shape shown in FIG. 17 generally resembles a partial dog-bone or dumbbell. As with the first pet toy 105, the foregoing example is merely illustrative and is not intended to limit the at least partially frozen or solidified substance to any particular shape.

Any bodies or other components of any pet toy mold may include a palatability enhancer. The palatability enhancer may be embedded within or coated on such bodies or other components. Further, the palatability enhancer may be uniformly distributed throughout or on such bodies or other components or concentrated in one or more areas within or on them. A more uniform distribution may be used to attract the animal equally to the bodies or other components of the pet toy mold. Concentrating the palatability enhancer in one or more predetermined regions may focus the animal's attention on specific portions of the pet toy mold.

The palatability enhancer may be any substance that generally triggers a chemical reaction in an animal that causes it to continue to chew, lick, eat, or otherwise play with the pet toy. The palatability enhancer may also emit an odor that initially attracts the animal to the pet toy or pet toy mold. Palatability enhancers may be made wholly or partially from meat or poultry broth concentrate or spray-dried powder, hydrolyzed proteins, yeast and/or yeast extract, liver, or any combination such ingredients. One suitable palatability enhancer is 6C2 enhancer, supplied by Applied Food Biotechnology International, Inc. of St. Charles, Mo.

Any bodies or other components of any pet toy mold may incorporate scents attractive to animals to attract the animal to the pet toy or pet toy mold. Such scents may be noticeable by, and less pleasing to, humans. One such exemplary scent is Givaudan 96625332 Spearmint. Palatability enhancers may also emit odors attractive to animals but less pleasing to humans. To hide such odors from detection, pet toy mold bodies or other components may further include a masking scent such as vanilla, mint, or the like. The masking scent may be sufficiently concentrated to mask the odors emitted from palatability enhancers and animal attraction scents from detection by humans while not masking these odors from animals, which generally have a keener sense of smell. In other words, the odors that may be unpleasing to humans remain detectable to the animal to attract the animal to the pet toy or pet toy mold but masked from detection by humans by a second odor.

Like the palatability enhancer, the masking scent may be embedded within or coated on the bodies or other components of a pet toy mold. The masking scent may be uniformly distributed throughout or on such bodies or other components or concentrated in one or more areas within them. A more uniform distribution may be used to maintain the masking scent within the pet toy or the pet mold as the animal consumes the pet toy or pet toy mold or separates it into multiple, independent portions.

Any bodies or other components of any pet toy mold may include other optional substances such as dental cleaning agents, flavoring agents, colorants, breath freshening agents, and the like embedded within or coated on these bodies or other components. A phosphate may be a suitable dental cleaning agent. Suitable breath-freshening agents may include parsley, kelp, or some combination thereof. Likewise, suitable flavoring agents may include garlic, meat flavoring (such as juices, pastes or powders), cheese flavors, fruit flavors, smoke flavors, or any combination thereof. Suitable colorants may include natural or synthetic dyes or pigments.

The thickness of any body for any pet toy mold may be uniform or may vary. Any holes formed in any body of the pet toy may be circular (as shown, for example, in FIGS. 6, 7, 9, and 10), cruciform shaped, or any other desired shape. Any hole defined in any body of a pet toy mold may be sized to hold pet treats or other snacks for the animal. The portion of a body around any hole may be sufficiently flexible to allow the hole to be expanded in order to receive and/or release a pet treat.

The holes may also receive a rope or the like, which may be knotted for retaining the rope with the body associated with the hole. The rope may be used to play with the animal, provide flossing or other dental care for the animal, or to provide an object for a person to hold to avoid touching the pet toy when picking it up or when throwing the toy for retrieval by the animal.

Although potential shapes of the pet toy mold and pet toy are described above and depicted in FIGS. 1-18 with certain specificity, the pet toy mold and/or pet toy may be formed into any desired shape. Further, the afore-described holes, grooves, recesses and/or projections are entirely optional.

It should be noted that all directional references set forth herein (e.g., upper, lower, upward, downward, left, right, leftward, rightward, top, bottom, above, below, vertical, horizontal, clockwise, and counterclockwise) are relative and only used for identification purposes to aid the reader's understanding of the embodiments of the present invention, and are not limitations, particularly as to the position, orientation, or use of the invention unless specifically set forth in the claims. References to any joinder of elements (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A pet toy comprising:
a generally non-edible portion including a body defining an open area; and
an at least partially solid edible portion joined to the generally non-edible portion, wherein:
the at least partially solid edible portion comprises a substance converted from a liquid or semi-liquid state to an at least partially solid state;
conversion of the substance from the liquid or semi-liquid state to the at least partially solid state joins the at least partially solid edible portion to the generally non-edible portion;
an outer surface of the pet toy includes both the generally non-edible portion and the at least partially solid edible portion; and
at least a part of the at least partially solid edible portion is contained within the open area.

2. The pet toy of claim 1, wherein the generally non-edible portion comprises rubber.

3. The pet toy of claim 1, wherein the substance comprises water.

4. The pet toy of claim 1, wherein the generally non-edible portion further includes an anchoring system that anchors the at least partially solid edible portion to the generally non-edible portion.

5. The pet toy of claim 4, wherein the anchoring system comprises a column extending from the body.

6. The pet toy of claim 1, wherein the body defines at least one hole.

7. The pet toy of claim 1, wherein the body includes:
a base;
a sidewall extending from the base; and
the base and the sidewall define the open area.

8. The pet toy of claim of claim 1, wherein the body includes at least two partial spherical sections spaced apart from each other and joined together by a partial cylindrical section.

9. A pet toy comprising:
a generally non-edible portion including a body defining an open area; and
a frozen liquid portion joined to the generally non-edible portion, wherein:
an outer surface of the pet toy includes both the generally non-edible portion and the frozen liquid portion; and
at least a part of the frozen liquid portion is contained within the open area.

10. The pet toy of claim 9, wherein the frozen portion comprises ice.

11. The pet toy of claim 9, wherein the generally non-edible portion comprises rubber.

12. The pet toy of claim 9, wherein the generally non-edible portion further includes an anchoring system that anchors the frozen portion to the generally non-edible portion.

13. The pet toy of claim 12, wherein the anchoring system comprises a column extending from the body.

14. The pet toy of claim 9, wherein the body defines at least one hole.

15. The pet toy of claim 9, wherein the body includes:
a base;
a sidewall extending from the base; and
the base and the sidewall define the open area.

16. The pet toy of claim of claim 9, wherein the body includes at least two partial spherical sections spaced apart from each other and joined together by a partial cylindrical section.

17. A pet toy mold comprising:
a first body;
a second body selectively joined to the first body;
the first and second bodies defining a chamber;
at least one of the first and second bodies comprising a material that forms a substantially liquid-tight seal between the bodies when the first and second bodies are selectively joined.

18. The pet toy mold of claim 17, wherein at least one of the first and second bodies define at least one hole that provides access to the chamber.

19. The pet toy mold of claim 17, wherein the material comprises rubber.
